(19) United States
(12) Patent Application Publication
(10) Pub. No.: US 2010/0238251 A1
(43) Pub. Date: Sep. 23, 2010

(54) Image forming device

(75) Inventor: Yoshiyuki Tsuzawa, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,332

(22) Filed: Mar. 4, 2010

(30) Foreign Application Priority Data
Mar. 17, 2009 (JP) 2009-064865

(51) Int. Cl. B41J 2/01; B41J 11/66

(52) U.S. Cl. 347/104; 400/621

(57) ABSTRACT

An image forming device has an image forming unit, a cutting unit, a conveyance path and an adjustment unit. The image forming unit sequentially forms images on a recording medium. The cutting unit cuts the recording medium between images. The conveyance path is provided with a change-curve portion that changes the conveyance direction of the recording medium and imparts curvature to the recording medium, and conveys the recording medium to the cutting unit. The adjustment unit temporarily interrupts conveyance of the recording medium at the change-curve portion and adjusts any difference between the processing speed of image forming by the image forming unit and the processing speed of cutting by the cutting unit.

### CROSS-REFERENCE TO RELATED APPLICATIONS

This application claims priority under 35 USC 119 from Japanese Patent Application No. 2009-64865 filed on Mar. 17, 2009, the disclosure of which is incorporated by reference herein.

### BACKGROUND OF THE INVENTION

1. Field of the Invention

The present invention relates to an image forming device that, in particular, sequentially forms images on an elongated recording medium, and forms individual images by cutting the recording medium between the respective images.

2. Description of the Related Art

Image forming devices that sequentially form images on a recording medium such as elongated recording paper, and form individual images by cutting the recording medium between the respective images, are widely known.

In this kind of image forming device, since images are sequentially formed on an elongated recording medium and the recording medium is cut between the images, the productivity of image formation is lowered when conveyance of the recording medium is stopped while cutting the recording medium.

Japanese Patent Application Laid-Open (JP-A) No. 2006-281684 describes a technique whereby the recording paper is conveyed so as to form a slackened portion between the printer that forms the images on the elongated recording paper and the cutting portion that cuts the recording paper.

However, in this technique, the slackening of the recording paper does not address the problem of fluctuations in load being propagated due to the resilience of the recording paper when the recording paper is conveyed and resulting in image irregularities.

### SUMMARY OF THE INVENTION

The present invention has been made in view of the above circumstances and provides a image forming device.

According to an aspect of the invention, an image forming device is provided which includes: an image forming unit that sequentially forms images on an elongated recording medium that is being conveyed; a cutting unit that cuts the recording medium, on which images have been formed, between the images; a conveyance path that is provided, at least one portion thereof, with a change-curve portion that changes a conveyance direction of the recording medium and imparts curvature to the recording medium, the conveyance path conveying the recording medium, on which images have been formed by the image forming unit, to the cutting unit; and an adjustment unit that temporarily interrupts conveyance of the recording medium at the change-curve portion and adjusts any difference between a processing speed of image forming by the image forming unit and a processing speed of cutting by the cutting unit.

### BRIEF DESCRIPTION OF THE DRAWINGS

Preferred embodiments of the present invention will be described in detail based on the following figures, wherein:

FIG. 1 is a lateral view showing the configuration of an image forming device according to an exemplary embodiment;

FIG. 2 is a perspective view showing the configuration of an adsorption conveyance portion according to the exemplary embodiment;

FIG. 3 is a sectional view showing the configuration of the adsorption conveyance portion according to the exemplary embodiment; and

FIG. 4 is a block diagram showing the configuration of the main components of the electrical system of the image forming device according to the exemplary embodiment.

### DETAILED DESCRIPTION OF THE INVENTION

The present invention provides an image forming device that can reduce the occurrence of image irregularities caused by fluctuations in load when conveying a recording medium.

An exemplary embodiment of the present invention is explained in the following.

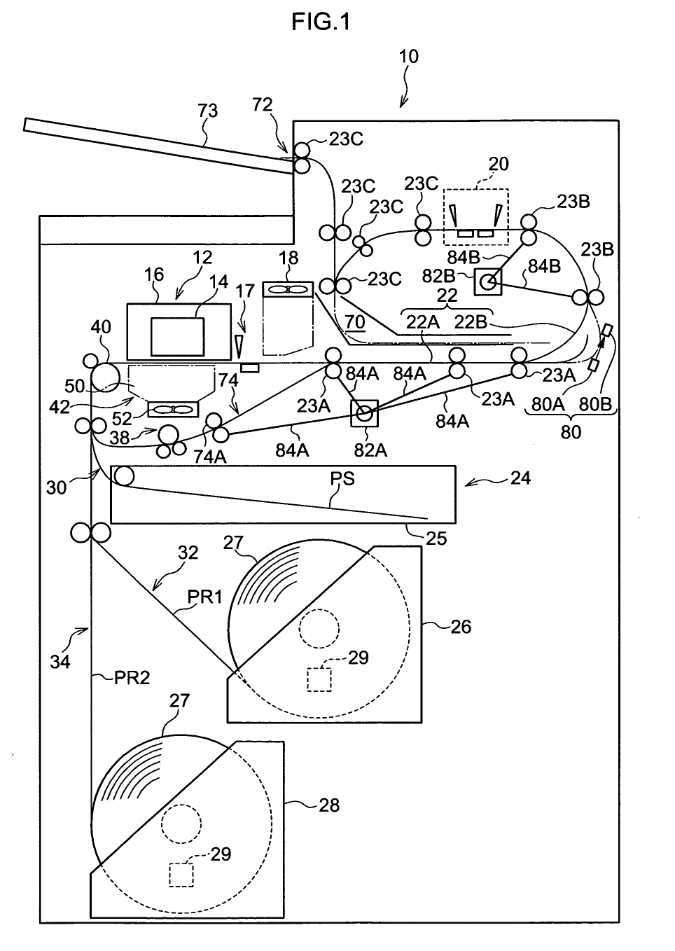

FIG. 1 presents a lateral view showing the configuration of image forming device 10 according to the present exemplary embodiment.

Image forming device 10 according to the present exemplary embodiment is provided with image forming unit 12 that forms images on recording paper. Image forming unit 12 has inkjet recording head 14, which ejects ink droplets toward the recording paper, and carriage 16, which holds inkjet recording head 14. The present exemplary embodiment is explained in terms of a color image forming device 10 that forms images with the four colors of yellow (Y), magenta (M), cyan (C) and black (K), but the embodiment may also be applied to a black-and-white image forming device.

Image forming device 10 is provided with rear-edge cutter 17 that cuts the rear edge of elongated recording paper described below, dryer 18 that solidifies ink droplets by supplying an airflow for drying toward the surface of recording paper on which an image has been formed by inkjet recording head 14, cutter 20 that cuts the recording paper between respective images, and main conveyance path 22 that conveys the recording paper sequentially to inkjet recording head 14, rear-edge cutter 17, dryer 18 and cutter 20. In FIG. 1, cutter 20 is portrayed with two blades; however, the number of blades may be limited to one. Further, cutter 20 corresponds to a cutting unit.

Main conveyance path 22 is provided with horizontal portion 22A that conveys the recording paper in a horizontal direction. The image formation position at which the inkjet recording head 14 forms images, the cutting position at which rear-edge cutter 17 performs cutting and the drying position to which dryer 18 supplies the airflow are disposed in this order along horizontal portion 22A. Plural pairs of rollers 23A that are for conveying the recording paper in accordance with the processing speed of the image formation performed by inkjet recording head 14, are provided along horizontal portion 22A. Further, roller pairs 23A and 23B correspond to an adjustment unit.

Main conveyance path 22 is provided with change-curve portion 22B that changes the conveyance direction of the recording paper upward, and curves the recording paper into a U-shape of a given curvature. Change-curve portion 22B is provided with plural pairs of rollers 23B that are for conveying the recording paper in accordance with the processing speed of the cutting performed by cutter 20. Change-curve portion 22B is configured to temporarily hold the recording paper by temporarily interrupting the conveyance of the recording paper and curving the recording paper to an outer side. In the present exemplary embodiment, the conveyance of the recording paper is temporarily interrupted at the portion at which the conveyance direction of the recording paper begins to change. Change-curve portion 22B is provided with paper sensor 80 that detects the recording paper at a position at which an amount of recording paper is held that is equivalent to one sheet of paper having formed thereon the largest size of image that can be formed (maximum-size image) and the recording paper is curved to the outer side. Paper sensor 80 is formed, for example, from light emitting device 80A and light receiving device 80B and the recording paper is detected by detecting, at light receiving device 80B, when light from light emitting device 80A is blocked off by the recording paper.

Recording paper that has passed through change-curve portion 22B is conveyed to cutter 20 and cut between respective images. Recording paper P that has been cut into image-sized lengths by cutter 20 is conveyed by plural pairs of rollers 23C, temporarily held in switchback storage portion 70, and then discharged to tray 73 via paper outlet 72, having had the conveyance direction thereof reversed.

Image forming device 10 is provided with reverse conveyance path 74 for double-sided printing. Reverse conveyance path 74 is configured to include roller pair 74A. Recording paper that has had an image formed on one side by inkjet recording head 14 is supplied again to main conveyance path 22 having had its front and back surfaces reversed at reverse conveyance path 74. This enables formation of images on both surfaces of recording paper.

Roller pairs 23A on main conveyance path 22 and roller pair 74A on reverse conveyance path 74 are rotationally driven by drive force transmitted from motor 82A via drive transmission paths 84A. Roller pairs 23B on change-curve portion 22B are rotationally driven by drive force transmitted from motor 82B via drive transmission paths 84B. That is, in the present exemplary embodiment, the drive source and drive transmission lines driving roller pairs 23A and roller pair 74A are separate from the drive source and drive transmission lines driving roller pairs 23B. Further, motor 82A corresponds to a first drive source and motor 82B corresponds to a second drive source.

Image forming device 10 is provided with paper sheet supply portion 24 that supplies sheets of recording paper PS, and first paper roll supply portion 26 and second paper roll supply portion 28 that supply elongated recording paper. Paper sheet supply portion 24 is provided with paper-supply cassette 25 that stores recording paper such that the upper side of the recording paper is exposed to the atmosphere.

Paper-supply cassette 25 is configured so as to be able to store different sizes of sheets of recording paper PS by, for example, adjusting the position of internal partition members or the like. Plural mechanical switches (not shown) for detecting the size of the stored sheets of recording paper PS are provided in paper-supply cassette 25. The plural mechanical switches are disposed so that combinations of on and off states change in accordance with the size of the stored sheets of recording paper PS by means of contact with the sheets of recording paper PS. The size of the stored recording paper PS can be detected in accordance with the combinations of on and off states of the respective mechanical switches.

First paper roll supply portion 26 and second paper roll supply portion 28 are configured so as to be able to store recording paper roll 27, which is elongated recording paper wound in a roll and having a width, for example, of from 102 mm to 254 mm. First paper roll supply portion 26 and second paper roll supply portion 28 are also provided with plural mechanical switches (not shown) for detecting the width of the stored recording paper roll 27. In addition, first paper roll supply portion 26 and second paper roll supply portion 28 are respectively provided with paper-level sensor 29 that detects the amount of recording paper remaining based on the thickness of recording paper roll 27. Alternatively, the amount of recording paper remaining may be detected based on the weight of recording paper roll 27.

Image forming device 10 is provided with sheet conveyance portion 30 that conveys sheets of recording paper PS fed from paper sheet supply portion 24, first roll conveyance portion 32 that conveys elongated recording paper PR1 wound out from first paper roll supply portion 26, and second roll conveyance portion 34 that conveys elongated recording paper PR2 wound out from second paper roll supply portion 28 (below, in view of convenience of explanation, recording papers PS, PR1 and PR2 are collectively referred to as recording paper P).

Image forming device 10 is provided with sub-scanning roller 40 that feeds recording paper P from paper sheet supply portion 24, first paper roll supply portion 26, second paper roll supply portion 28 and reverse conveyance path 74 to main conveyance path 22. Sheets of recording paper PS, elongated recording paper PR1 and elongated recording paper PR2 are selectively conveyed to main conveyance path 22 via sub-scanning roller 40.

Recording paper P is, for example, photographic print paper used for printing photographs or normal paper. Photographic print paper has a coating layer formed on both surfaces that includes water absorbent silica particles. Accordingly, as one surface of recording paper P is dried, the coating layer on the side of the one surface contracts and the surface curls concavely. In the case of normal paper, too, when one side contacts the atmosphere, paper fibers contract as the surface is dried and the surface curls concavely in a similar manner. Paper that has a coating layer on both surfaces that includes water absorbent silica particles such as paper that has been used for books of photographs in recent years has similar properties. In addition, recording paper roll 27, because it is wound in a roll, curls concavely at the side of the paper toward the inner side of the roll.

Adsorption conveyance portion 42 is provided on main conveyance path 22 in order to ensure that the recording paper being conveyed at the position at which an image is formed by inkjet recording head 14 remains flat while securing a fixed distance between the recording paper and inkjet recording head 14. Adsorption conveyance portion 42 is configured so as to adsorb recording paper P fed from roller 40 and to convey the recording paper in a state of adsorption to the region at which an image is formed at image forming unit 12 (that is, directly beneath inkjet recording head 14).

De-curling conveyance portion 38 that subjects the recording paper to de-curling treatment is provided at reverse conveyance path 74. De-curling conveyance portion 38 de-curls the recording paper which has a concavely curled upper surface, and curls the recording paper such that the surface curls convexly on main conveyance path 22.

Mechanism of Adsorption Conveyance Portion

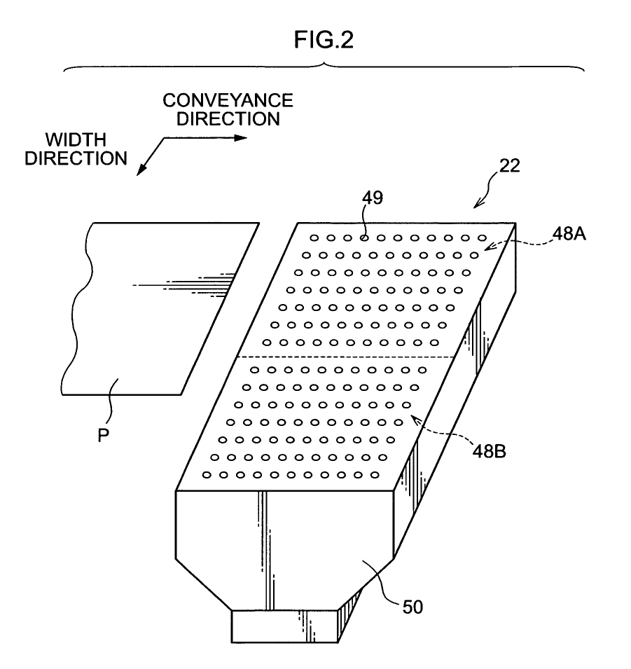

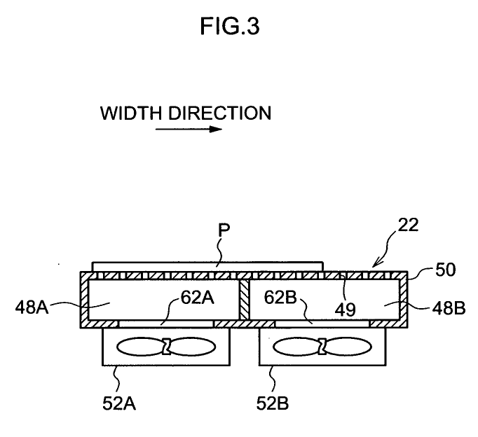

FIG. 2 is a perspective view showing the configuration of adsorption conveyance portion 42, and FIG. 3 is a sectional view along the width direction of adsorption conveyance portion 42.

Adsorption conveyance portion 42 is provided with air chamber-forming member 50 that forms main conveyance path 22 at an upper side thereof and also forms two air chambers 48A and 48B along the width direction of recording paper P, and is also provided with two suction fans 52A and 52B provided so as to correspond to air chambers 48A and 48B, respectively, that perform negative-pressure suction.

Air chamber-forming member 50 is formed to have a greater width with respect to the width direction of recording paper P than the greatest width of recording paper P that can be used in image forming device 10, and plural suction holes 49 are disposed at the upper surface of air chamber-forming member 50 forming main conveyance path 22, so as to communicate air chambers 48 with main conveyance path 22. Openings 62A and 62B are formed at the bottom side of air chamber-forming member 50 so that suction fans 52A and 52B are communicated with air chambers 48A and 48B, respectively.

Recording paper P is conveyed by adsorption conveyance portion 42 such that one edge of recording paper P in a width direction is aligned with one edge of air chamber-forming member 50 in a width direction.

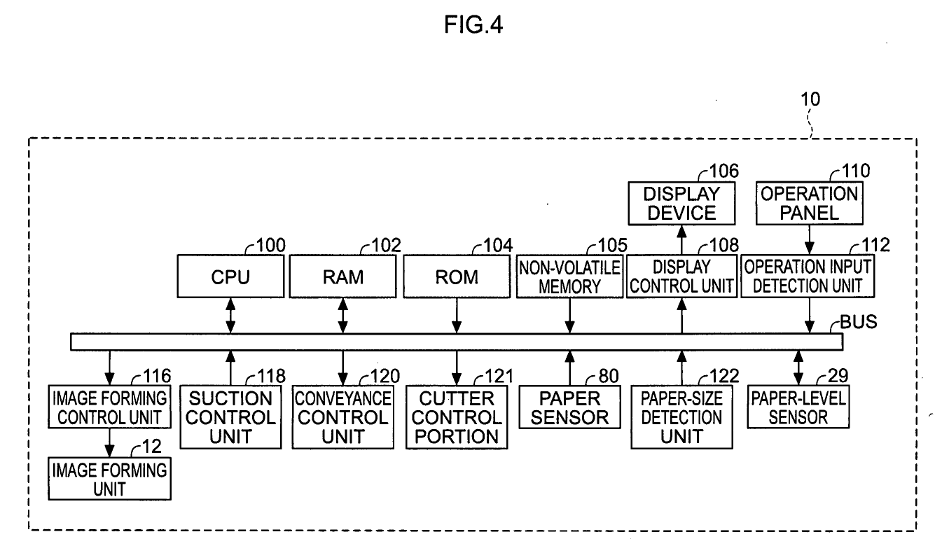

FIG. 4 shows the configuration of the main components of the electrical system of image forming device 10.

As shown in this drawing, image forming device 10 is provided with: CPU (central processing unit) 100 that controls the operations of the device as a whole; RAM 102 that temporarily stores various kinds of data; ROM 104 in which various kinds of programs and the like are stored in advance, including control programs that control the device as a whole; non-volatile memory 105 that stores various kinds of information; display control unit 108 that is connected to and controls display device 106, which is a liquid crystal display panel or the like that displays various kinds of operation screens; and operation input detection unit 112 that is connected to operation panel 110, at which various kinds of operation commands are input by a user, and that detects operations executed at operation panel 110. CPU 100 corresponds to an adjustment unit.

Image forming device 10 is provided with: image forming control unit 116 that controls the image formation processing by image forming unit 12 described above; suction control unit 118 that controls suction fans 52A and 52B at adsorption conveyance portion 42; conveyance control unit 120 that controls the conveyance of recording paper P; and cutter control portion 121 that controls cutting operations by rear-edge cutter 17 and cutter 20.

Conveyance control unit 120 controls sheet conveyance portion 30, first roll conveyance portion 32 and second roll conveyance portion 34 and selectively conveys recording paper P to main conveyance path 22. Conveyance control unit 120 controls motor 82A and motor 82B and controls the conveyance of recording paper P along main conveyance path 22.

CPU 100, RAM 102, ROM 104, non-volatile memory 105, display control unit 108, operation input detection unit 112, image forming control unit 116, suction control unit 118, conveyance control unit 120 and cutter control portion 121 are interconnected via system bus BUS. Accordingly, it is possible to perform each of access to CPU 100, RAM 102, ROM 104 and non-volatile memory 105, control of the display of various kinds of information such as operation screens and various messages at display device 106 via display control unit 108, control of the operation of image forming unit 12 via image forming control unit 116, control of the suction of recording paper P via suction control unit 118, control of the conveyance of recording paper P via conveyance control unit 120, and control of the operation of rear-edge cutter 17 and cutter 20 via cutter control portion 121. CPU 100 is able to determine the operation content executed at operation panel 110 based on the operation information detected by operation input detection unit 112.

System bus BUS is also connected to paper sensor 80. Accordingly, CPU 100 is able to determine whether or not an amount of recording paper equivalent to one sheet having the maximum-size image formed thereon is held at change-curve portion 22B.

System bus BUS is also connected to paper-size detection unit 122 and paper-level sensor 29. Paper-size detection unit 122 stores paper-width information indicating the width of recording paper PS for each size of sheet recording paper PS. Paper-size detection unit 122 detects the size of recording paper PS stored in paper-supply cassette 25 based on the combination of on- and off-states of the plural mechanical switches provided at paper-supply cassette 25, and derives the width of the detected recording paper PS based on the paper-width information. Paper-size detection unit 122 detects the width of recording paper roll 27 stored in first paper roll supply portion 26 and second paper roll supply portion 28 based on the combination of on- and off-states of the plural mechanical switches provided at both first paper roll supply portion 26 and second paper roll supply portion 28. Accordingly, CPU 100 is able to determine the width of recording paper PS stored in paper-supply cassette 25 and the width of recording paper roll 27 stored in first paper roll supply portion 26 and second paper roll supply portion 28, and to determine the amount of recording paper roll 27 remaining in first paper roll supply portion 26 and second paper roll supply portion 28.

Mechanisms and Effects

In the following, the mechanisms and effects of the present exemplary embodiment are explained.

When an image is formed, recording paper P that is to be used in the image formation is selected from sheets of recording paper PS, elongated recording paper PR1 and elongated recording paper PR2 and conveyed to main conveyance path 22. At adsorption conveyance portion 42, recording paper P is conveyed such that one edge of recording paper P in a width direction is aligned with one edge of air chamber-forming member 50 in a width direction. When no suction force is exerted from adsorption conveyance portion 42, recording paper P curls slightly convexly relative to main conveyance path 22.

When performing image formation on recording paper P, CPU 100 determines the width of the recording paper P that is to be used in the image formation. When the width of the recording paper P that is to be used in the image formation is less than the width of air chamber 48A, CPU 100 controls adsorption conveyance portion 42 and causes suction fan 52A to initiate negative pressure suction, thereby causing recording paper P to be adsorbed to adsorption conveyance portion 42 only in the region corresponding to air chamber 48A. When the width of the recording paper P that is to be used in the image formation is greater than the width of air chamber 48A, CPU 100 controls adsorption conveyance portion 42 and causes suction fans 52A and 52B to initiate negative pressure suction, thereby causing recording paper P to be adsorbed to adsorption conveyance portion 42 in the regions corresponding to air chambers 48A and 48B.

CPU 100 controls mage forming unit 12, thereby moving carriage 16 in a scanning manner and ejecting ink droplets from inkjet recording head 14 to form images each having a fixed width on recording paper P. Each time an image having a fixed width is formed, CPU 100 controls motor 82A via conveyance control unit 120, rotationally driving roller pairs 23A and intermittently conveying recording paper P in the conveyance direction.

As a result, recording paper P is conveyed while being adsorbed to adsorption conveyance portion 42 and an image is formed on the upper surface of recording paper PS with ink droplets ejected from inkjet recording head 14 at image forming unit 12.

Warm air is directed from dryer 18 onto recording paper P that has had an image formed thereon and the ink droplets are solidified. Elongated recording paper PR1 and elongated recording paper PR2 are cut at the rear side of the image by rear-edge cutter 17. Having passed rear-edge cutter 17 and dryer 18, recording paper P is conveyed to change-curve portion 22B and temporarily held at change-curve portion 22B by being curved outward.

When the amount of recording paper P held at main conveyance path 22 is equivalent to one sheet having the maximum-size image formed thereon and recording paper P is detected by paper sensor 80, CPU 100 controls motor 82B via conveyance control unit 120, rotationally driving roller pairs 23B and conveying an amount of recording paper P equivalent to only one image, and then controls cutter 20 via cutter control portion 121 to cut recording paper P into image-sized lengths.

Recording paper P that has been cut into an image-sized length is temporarily held in switchback storage portion 70, and then discharged to tray 73 via paper outlet 72, having had the conveyance direction thereof reversed.

When an image is to be formed on both surfaces of recording paper P, the conveyance direction of recording paper P is switched after recording paper P has passed rear-edge cutter 17 and dryer 18, and recording paper P is conveyed onto reverse conveyance path 74.

The solvent included in the ejected ink droplets is absorbed by the coating layer or the paper fibers of recording paper PS, whereby the upper surface side of recording paper sheet PS absorbs more moisture than the lower surface side thereof and expands. As a result, a force is exerted that makes recording paper PS curl more convexly toward the upper surface side.

At reverse conveyance path 74, recording paper sheet PS is subjected to decurling treatment at de-curling conveyance portion 38. In this way the direction of curl of recording paper PS that has been subjected to decurling treatment at de-curling conveyance portion 38 is reversed. That is, in the state in which recording paper PS is fed out from de-curling conveyance portion 38, recording paper PS is convexly curled upward, namely, convexly curled upward on main conveyance path 22. Accordingly, when recording paper sheet PS is conveyed on main conveyance path 22 for formation of the second image (formation of an image on the reverse surface), recording paper PS is conveyed with its shape aligned with the shape of the conveyance path as during the formation of the first image, and the leading edge of recording paper PS does not lift up from main conveyance path 22.

According to the present exemplary embodiment as explained above, main conveyance path 22 conveys elongated recording paper P, which has had an image formed thereon by image forming unit 12, to cutter 20, and the direction of conveyance of recording paper P is changed at a portion of main conveyance path 22. Change-curve portion 22B is provided that imparts curvature to the recording paper P, conveyance of recording paper P is temporarily interrupted at change-curve portion 22B, and any difference between the processing speed of image formation and the processing speed of cutting is adjusted. As a result, even if fluctuations in load occur when recording paper P is conveyed, image irregularities caused by fluctuations in load when conveying recording paper P can be suppressed because fluctuations in load caused by changing the conveyance direction of recording paper P are not propagated.

According to the present exemplary embodiment, conveyance of recording paper P is temporarily interrupted at the portion of change-curve portion 22B at which the conveyance direction of recording paper P conveyed from image forming unit 12 begins to change. As a result, fluctuations in load are not propagated because recording paper P is curved under the force of conveyance from image forming unit 12 and fluctuations in load from the downstream side in the conveyance direction are absorbed.

According to the present exemplary embodiment, motor 82A and drive transmission paths 84A that convey recording paper P in accordance with the processing speed of image formation by image forming unit 12, and motor 82B and drive transmission paths 84B that convey recording paper P in accordance with the processing speed of cutting by cutter 20, are separated. As a result, even if fluctuations in load occur in the transmission paths of the drive force at the side of cutter 20, transmission of these load fluctuations to the side of image forming unit 12 can be prevented.

In particular, at image forming unit 12, which forms an image by ejecting ink droplets onto recording paper P according to an inkjet method, it is important to ensure that recording paper P is flat in order to form a high-quality image and, in addition, to maintain a constant distance between recording paper P and image forming unit 12 when printing. For this reason, it is preferable to have main conveyance path 22 arranged in a horizontal direction at the position where image formation is performed by image forming unit 12 and to change the conveyance direction of recording paper P being conveyed horizontally to an upward direction at change-curve portion 22B.

In the above exemplary embodiment, explanation has been given with respect to a case in which change-curve portion 22B is able to hold an amount of recording paper equivalent to one sheet of paper having the maximum size of image formed thereon; however, the present invention is not limited thereto as long it is able to hold at least one sheet's worth, and may be configured to hold several sheets' worth of paper.

In the above exemplary embodiment, explanation has been given with respect to a case in which paper sensor 80 provided at change-curve portion 22B detects whether or not one sheet's worth of recording paper is held; however, the present invention is not limited thereto. For example, the length of paper held may be detected by calculating the difference between the distance recording paper P is conveyed by roller pairs 23A and the distance recording paper P is conveyed by roller pairs 23B and determining the length of paper held from the difference in conveyance distance.

In the above exemplary embodiment, explanation has been given with respect to a case in which the size or width of recording paper P is determined by providing plural mechanical switches at paper-supply cassette 25, first paper roll supply portion 26 and second paper roll supply portion 28; however, the present invention is not limited thereto. For example, the size of recording paper P may be specified by a user inputting the size of recording paper P at operation panel 110.

In the above exemplary embodiment, explanation has been given with respect to a case in which adsorption conveyance portion 42 is configured by two air chambers 48A and 48B arranged relative to the width of recording paper P and two suction fans 52A and 52B corresponding to air chambers 48A and 48B, respectively; however, the present invention is not limited thereto. For example, two or more suction fans may be provided at one air chamber and the number of suction fans that are operated may be increased or decreased in accordance with the width of recording paper P.

In the above exemplary embodiment, explanation has been given with respect to a case in which an inkjet-process image forming device is applied to the present invention; however, the present invention is not limited thereto. For example, image forming devices utilizing other processes such as an electrophotographic process may be applied to the present invention.

The configuration of image forming device 10 (refer to FIG. 1), the configuration of adsorption conveyance portion 42 (refer to FIGS. 2 and 3) and the configuration of the electrical system of image forming device 10 (refer to FIG. 4) explained in the above exemplary embodiment are merely examples and it should be understood that they may be modified within the scope of the gist of the present invention.

According to a first aspect of the present invention, an image forming device is provided which includes: an image forming unit that sequentially forms images on an elongated recording medium that is being conveyed; a cutting unit that cuts the recording medium, on which images have been formed, between the images; a conveyance path that is provided, at least one portion thereof, with a change-curve portion that changes a conveyance direction of the recording medium and imparts curvature to the recording medium, the conveyance path conveying the recording medium, on which images have been formed by the image forming unit, to the cutting unit; and an adjustment unit that temporarily interrupts conveyance of the recording medium at the change-curve portion and adjusts any difference between a processing speed of image forming by the image forming unit and a processing speed of cutting by the cutting unit.

According to the first aspect, a change-curve portion is provided that changes the conveyance direction of, and imparts curvature to, a recording medium at least one portion of a conveyance path conveying, to a cutting unit. The recording medium has had an image formed thereon by an image forming unit. Conveyance of the recording medium is temporarily interrupted at the change-curve portion and any difference between the processing speed of image forming and the processing speed of cutting is adjusted. As a result, even if fluctuations in load occur when the recording medium is conveyed, image irregularities caused by fluctuations in load when conveying the recording medium can be suppressed because fluctuations in load caused by changing the conveyance direction of the recording medium are not propagated.

According to a second aspect of the present invention, in the image forming device in the first aspect, the adjustment unit temporarily interrupts the conveyance of the recording medium at a portion of the change-curve portion at which the conveyance direction of the recording medium fed from the image forming unit begins to change.

According to a third aspect of the present invention, in the image forming device in the first aspect, the adjustment unit includes: a first drive source that conveys the recording medium in accordance with the processing speed of the image forming by the image forming unit; and a second drive source that conveys the recording medium in accordance with the processing speed of the cutting by the cutting unit.

According to a fourth aspect of the present invention, in the image forming device in the first aspect, the image forming unit includes an inkjet system that forms images by ejecting ink droplets onto the recording medium; and the conveyance path is formed along a horizontal direction at a position where the image forming is performed by the image forming unit and changes the conveyance direction of the recording medium being conveyed horizontally to an upward direction at the change-curve portion.

According to the present invention, an effect is achieved whereby image irregularities caused by fluctuations in load when conveying a recording medium can be suppressed.

Embodiments of the present invention are described above, but the present invention is not limited to the embodiments as will be clear to those skilled in the art.

What is claimed is:

1. An image forming device, comprising:
an image forming unit that sequentially forms images on an elongated recording medium being conveyed;
a cutting unit that cuts the recording medium, on which images have been formed, between the images;
a conveyance path that is provided, at least one portion thereof, with a change-curve portion that changes a conveyance direction of the recording medium and imparts curvature to the recording medium, the conveyance path conveying the recording medium, on which images have been formed by the image forming unit, to the cutting unit; and
an adjustment unit that temporarily interrupts conveyance of the recording medium at the change-curve portion and adjusts any difference between a processing speed of image forming by the image forming unit and a processing speed of cutting by the cutting unit.

2. The image forming device according to claim 1, wherein the adjustment unit temporarily interrupts the conveyance of the recording medium at a portion of the change-curve portion at which the conveyance direction of the recording medium fed from the image forming unit begins to change.

3. The image forming device according to claim 1, wherein the adjustment unit comprises:
a first drive source that conveys the recording medium in accordance with the processing speed of the image forming by the image forming unit; and
a second drive source that conveys the recording medium in accordance with the processing speed of the cutting by the cutting unit.

4. The image forming device according to claim 1, wherein:
the image forming unit comprises an inkjet system that forms images by ejecting ink droplets onto the recording medium; and
the conveyance path is formed along a horizontal direction at a position where the image forming is performed by the image forming unit and changes the conveyance direction of the recording medium being conveyed horizontally to an upward direction at the change-curve portion.
